(19) United States
(12) Patent Application Publication
(10) Pub. No.: US 2008/0232803 A1
(43) Pub. Date: Sep. 25, 2008

(54) Hybrid Optical Network and a Method of Routing Data Packets in a Hybrid Optical Network

(75) Inventor: Martin Maier, Berlin (DE)

Correspondence Address: WORKMAN NYDEGGER, 60 EAST SOUTH TEMPLE, 1000 EAGLE GATE TOWER, SALT LAKE CITY, UT, 84111, US

(73) Assignee: Technische Universität Berlin, Berlin (DE)

(21) Appl. No.: 10/597,560

(22) PCT Filed: Jan. 26, 2005
(86) PCT No.: PCT/EP2005/000932

§ 371 Date: Oct. 6, 2006

(30) Foreign Application Priority Data
Jan. 30, 2004 (EP) 04090028.4

(51) Int. Cl. H04J 14/00; H04B 10/20

(52) U.S. Cl. 398/59

(57) ABSTRACT

A hybrid optical network comprising a single channel optical ring network with a plurality of ring nodes and a star subnetwork. The star subnetwork comprises a central wavelength router, a plurality of combiners being connected to input ports of the central wavelength router, and a subset of the ring nodes of the ring network, each node of the subset including a tunable transmitter and a tunable receiver to communicate optical data packets over the star subnetwork. Optical data packets routed between two ring nodes of the subset over the star subnetwork are assigned a specific wavelength that determines the routing of the data packets through the central wavelength router. The invention further regards a method of routing data packets between a source ring node and a destination ring node of a hybrid optical network.

### CROSS-REFERENCE TO A RELATED APPLICATION

This application is a National Phase patent application of International Patent Application Number PCT/EP2005/000932, filed on Jan. 26, 2005, which claims priority of European Patent Application Number 04090028.4, filed on Jan. 30, 2004.

### BACKGROUND

The invention regards a hybrid optical network with a single channel optical ring network and a star network as well as a method of routing data packets in a hybrid optical network. More particularly, the invention regards an evolutionary multichannel upgrade of an optical single channel packed switched metropolitan area ring network and a method for routing traffic in such upgraded network.

Document WO 99/37050 describes a communications system including an optical network having a star topology in which all network nodes are connected to a central hub. In addition, a subset of the network nodes are connected via a peripheral ring network. The central hub consists of multiple WDM (wavelength division multiplex) routers. Traffic for another node is directed over the star network or the peripheral ring network depending on the shortest route.

Resilient Packet Ring IEEE 802.17 standard includes rules for channel utilization, throughput efficiency, service differentiation and resilience of optical single channel packet switched ring metropolitan area networks (MANs). IEEE 802.17 regards a bidirectional dual-fiber ring network with optical to electrical to optical signal conversion at each node. Each node is equipped with two fixed-tuned transmitters and two fixed-tuned receivers, one for each fiber ring.

There have been discussed ring networks that implement wavelength division multiplexing on the ring as an upgrade. However, such upgrade requires high investment costs as each node of the ring needs to be upgraded for WDM.

### SUMMARY

There is a need to provide for a hybrid optical network that allows an evolutionary, cost sensitive upgrade of known single channel optical ring network and a method of efficiently routing data packets in a hybrid optical network.

In one embodiment of the present invention there is provided a single channel optical ring network that is upgraded by a star subnetwork. The star subnetwork comprises nodes which are formed by a subset of the ring nodes of the ring network, i.e., only some of the ring nodes are also nodes of the star subnetwork. The star subnetwork additionally comprises a central wavelength router having a plurality of input ports and a plurality of output ports and a plurality of combiners each having a plurality of input ports and one output port, the output ports of the combiners being connected to the input ports of the central wavelength router. Each node of the subset includes a tunable transmitter and a tunable receiver to communicate optical data packets over the star subnetwork. The tunable transmitters are each connected to an input port of one of the combiners. Optical data packets routed between two ring nodes of the subset over the star subnetwork are assigned a specific wavelength that determines the routing of the data packets through the central wavelength router.

One embodiment of the present invention is based on the idea to improve a single channel optical ring network, in which all ring nodes are connected by the ring, with a star subnetwork, to which only some of the ring nodes additionally belong. This allows for an evolutionary upgrade of the network. Investment costs in the star subnetwork depend on the number of nodes that are added to the star subnetwork. To upgrade a node, only a transmitter and a receiver need to be added to the node. In addition, the use of combiners to which the nodes of the star subnetwork are connected additionally reduces the number of input ports and output ports of the central wavelength router. This way, the number of costs for the central wavelength router is considerably reduced as such costs are proportional to the number of ports.

Also, the combiners serve as concentrators of network nodes and allow to reduce the amount of optical fibers required in the star subnetwork as well as the costs for installing such fibers. Using combiners, it is not necessary to connect each node of the star subnetwork with a port of the central wavelength router. Furthermore, in case optical amplifiers are arranged between each combiner and the central wavelength router, such amplifiers are shared by a plurality of nodes of the star subnetwork, resulting in a reduced number of required amplifiers.

The present invention applies wavelength division multiplexing only on the central wavelength router based star subnetwork, while leaving the ring network unchanged.

In a further advantage, the present invention allows for a large spatial reuse factor as the mean hop distance of the network can be reduced by providing short-cuts over the star subnetwork. In particular, due to the short-cuts across the star subnetwork the hop distances on the ring network are decreased and the spatial reuse factor on the ring network is increased. Moreover, the central wavelength router as a wavelength routing device allows to spatially reuse all wavelengths at each port simultaneously.

It is pointed out that the terms “tunable transmitter” and “tunable receiver” as understood in the context of this invention denote both a transmitter or receiver that is tunable and an array of fixed-tuned transmitters or fixed-tuned receivers, in which “tuning” means to activate a transmitter or receiver of that array that emits or senses a desired wavelength. Also, a transmitter/receiver may consist of a combination of an array of fixed-tuned transmitters/receivers and one tunable transmitter/receiver. It is further pointed out that the tunable transmitter or tunable receiver can be combined in a tunable transceiver.

In a preferred embodiment of the invention, the central wavelength router is a single arrayed waveguide grating (AWG). There is only a single central router. The arrayed waveguide grating is a passive router. Due to its passive nature, the router is highly reliable.

In another preferred embodiment, the star subnetwork additionally comprises a plurality of wavelength independent splitters each having one input port and a plurality of output ports, the input ports of the splitters being connected to the output ports of the central wavelength router, the output ports of the splitters each being connected to a tunable receiver of one of the nodes of the subset. The use of splitters allows for multicasting. With multicasting, all network nodes connected to a splitter can receive a data packet which exits an output port of the central router. Accordingly, a data packet needs to be sent less frequently to reach a plurality of nodes such that network resources are saved. Further, by using splitters (and combiners) it is possible to add more nodes to the star subnetwork having a given number of input ports and output ports of the central wavelength router.

Preferably, the nodes of the subset are equally distributed among the ring nodes. This is advantageous to achieve a uniform traffic on the ring network and star subnetwork.

An optical amplifier may be arranged between the output port of a combiner and the corresponding input port of the central wavelength router and/or between an output port of the central wavelength router and the input port of the corresponding splitter. Such optical amplifier compensates for fiber losses, splitting losses and insertion losses in the star subnetwork. The amplifier is, e.g., an Erbium doped fiber amplifier.

In a further embodiment of the present invention, each node of the subset comprises conversion means for optical to electrical to optical conversion of the optical signals. The tunable transmitter and the tunable receiver of a node perform electrical to optical and optical to electrical signal conversion, respectively.

Preferably, each node of the subset comprises transit queues and station queues, the station queues comprising two receive queues and two transmit queues, one receive queue being connected to the ring, one receive queue being connected to the tunable receiver, one transmit queue being connected to the ring and one transmit queue being connected to the tunable transmitter. Data packets stored in a transit queue are transferred to another ring node (store and forward). Data packets stored in a station queue are received by the node or transmitted by the node and, if the node is not the destination node, are sent across or received by the star subnetwork.

The hybrid network preferably further comprises protocol means for routing optical data packets to be sent from a given source ring node to a given destination ring node over the shortest network path, including routing the data packets over the single channel ring network and over the star subnetwork. The shortest network path is determined, e.g., by a network management system which can be a central management system or a decentralized management system. The management system, e.g., modifies look-up routing tables in the network nodes. A media access control (MAC) protocol which belongs to the data link layer (layer two of the OSI reference model) is used to control access to the hybrid network. The MAC protocol aims at maximizing the capacity of the network.

In a preferred embodiment, the hybrid network additionally comprises: means for assigning a wavelength to data packets being sent over the star subnetwork from a given source subset node of the subset to a given destination subset node of the subset, the wavelength determining the route of the data packets through the star subnetwork; means for tuning the tunable transmitter of the source subset node to the assigned wavelength; and means for tuning the tunable receiver of the destination subset node to the assigned wavelength. This allows to send data from a given source subset node of the star subnetwork to a given destination subset node of the star subnetwork.

Said means for assigning a wavelength preferably comprise: means for determining the shortest route for data packets being sent from a given source ring node to a given destination ring node; means for determining within the shortest route a source subset node and a destination subset node routing the data packets over the star subnetwork in a short-cut; and means for determining a wavelength to route the data packets from the source subset node to the destination subset node. The shortest route can be calculated by simply determining the shortest number of hops from one node to another for the data packets to get to their destination. Using a short-cut over the star subnetwork counts as one hop. If data packets are routed over the star subnetwork, i.e., if a path across the subnetwork requires less hops than a path only over the optical ring, a wavelength is assigned to route the data packets across the star subnetwork, i.e., from a source subset node to a destination subset node. The tunable transmitter and the tunable receiver of the respective subset node are tuned to this wavelength.

Preferably, the network further comprises means for putting the data packets received at the destination subset node on the single channel optical ring network in case the destination subset node is different from the destination node.

In a preferred embodiment, the single channel optical ring network is a bidirectional dual-fiber ring network. On one peripheral fiber ring, data packets are sent in a first direction, on another peripheral fiber ring, data packets are sent in the opposite direction. There are provided electrical transit and station queues for either fiber ring. The use of a bidirectional ring is beneficial as data can be sent in both directions on the single channel optical ring. The spatial reuse factor is improved. However, the present invention may just as well be implemented with a single channel unidirectional optical ring network.

In another preferred embodiment, a passive star coupler is arranged in parallel with the central wavelength router, each node of the subset being coupled both to the central wavelength router and the passive star coupler. The central wavelength router routes data packets assigned to wavelengths of a first waveband and the passive star coupler broadcasts data packets assigned to wavelengths of a second waveband. This embodiment allows for routing additional data over the passive star coupler of the star subnetwork.

In another embodiment of the present invention there is provided a method of routing data packets between a source ring node and a destination ring node of a hybrid optical network that comprises a peripheral optical ring network with a plurality of ring nodes and a star network with a central wavelength router and a subset of the ring nodes, each node of the subset including means to communicate optical data packets over the star subnetwork. Preferably, the hybrid network as defined in claim 1 is used to carry out the method.

The method is based on the idea to add a third kind of data stripping to the well known source stripping (the source node pulls data packets from the ring) and destination stripping (the destination node pulls data packets from the ring) techniques. According to the inventive method, data are pulled from the ring by a node that is neither a source node nor a destination node. The node that pulls the data from the ring belongs to the star subnetwork and is termed source subset node. The pulled data packets are transmitted over the star subnetwork to a destination subset node of the star subnetwork. The data packets are then sent from the destination subset node to the destination ring node again over the optical ring network if the destination ring node is unequal to the destination subset node. The data packets are finally taken from the optical ring network by the destination ring node (destination stripping).

The inventive method will also be referred to as “proxy stripping” in contrast to the known methods of source stripping and destination stripping.

Preferably, the source subset node and the destination subset node are nodes of the shortest route for data packets from the source ring node to the destination ring node over the hybrid network. Shortest path routing including short-cuts over the star subnetwork is performed to increase the capacity of the network. The average number of hops (mean hop distance) is decreased.

However, it is pointed out that “proxy stripping” can be implemented in shortest path routing or alternatively in any arbitrary routing policy. In shortest path routing, the ring nodes need to “know” which subset node is closest to the own location. This knowledge is contained, e.g., in a routing table in each ring node. Alternatively, in a transparent form of proxy stripping, the ring nodes do not have any knowledge about the position of subset nodes on the ring. Proxy stripping is still executed, but the data packets may not take the shortest route from a ring node to a subset node. The advantage is that the ring nodes do not require information about the position of the subset nodes. This is an advantage in particular if an existing ring network is upgraded with a star subnetwork in an evolutionary manner.

In a preferred embodiment, the optical data signals on the optical ring network are converted to electrical data signals when taken from the ring. The electrical data signals are then converted to optical data signals of a specific wavelength that determines the routing of the data signals across the star subnetwork. In one embodiment, the optical data signals are placed in a transmit queue when taken from the optical ring network and transmitted from the transmit queue to a tunable transmitter of the source subset node.

The method preferably additionally comprises the step of regenerating the signal after conversion to an electrical signal. Such regeneration can be a 3R signal regeneration (reamplifying, reshaping, retiming) well known to the skilled person.

In a further preferred embodiment, the source subset node transmits control data with node reservation information to the other nodes of the subset prior to transmitting the data over the star subnetwork. The node reservation information may comprise data about the source address of the source subset node, data about the destination address of the destination subset node and data about the length of the corresponding data packet. The reservation protocol and control data may belong to the media access control (MAC) level of the network.

### BRIEF DESCRIPTION OF THE DRAWINGS

The invention is explained in more detail below on the basis of an exemplary embodiment with reference to the figures, in which:

FIG. 1 shows a hybrid optical network including a single channel optical ring network and a star subnetwork having an arrayed waveguide grating as central wavelength router;

FIG. 2 shows the main components of a ring node of the single channel optical ring network of FIG. 1;

FIG. 3 shows the main components of a ring node of the single channel optical ring network of FIG. 1 that also is a network node of the star subnetwork;

FIG. 4 shows in detail the arrangement of a plurality of combiners, a central arrayed waveguide grating and a plurality of splitters in the star subnetwork of FIG. 1;

FIG. 5 shows an alternative embodiment of a hybrid optical network including a single channel optical ring network and a star subnetwork, the star subnetwork comprising both a central arrayed waveguide grating and a central passive star coupler; and

FIG. 6 shows the main components of a ring node of the hybrid optical network of FIG. 5 that is also a network node of the star subnetwork.

### DETAILED DESCRIPTION

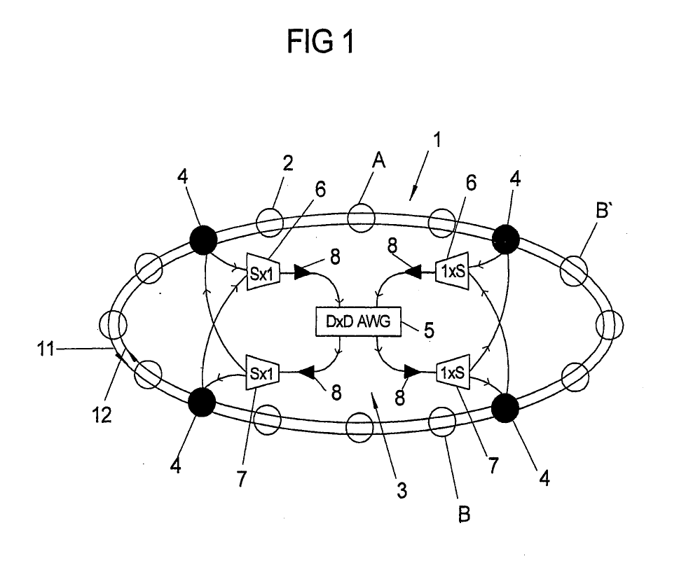

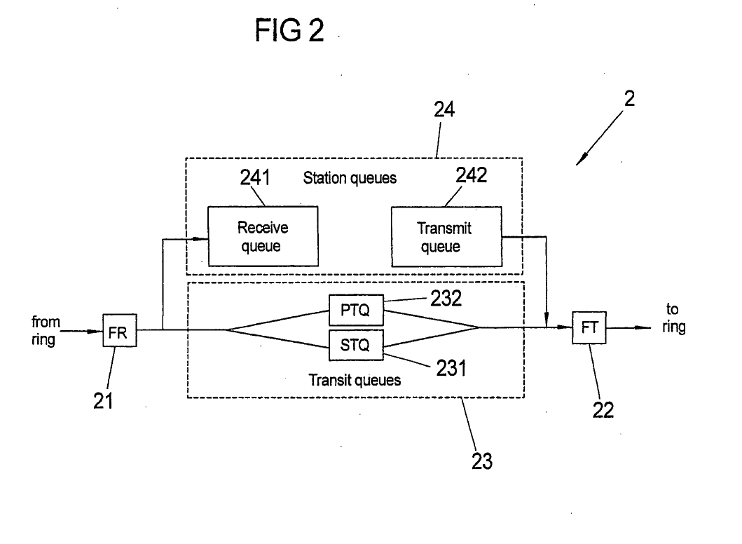

FIG. 1 depicts the network architecture of a hybrid optical network. The hybrid optical network includes a bi-directional dual-fiber ring consisting of two peripheral fibers 11, 12 and a plurality of ring nodes 2. Each of the ring nodes 2 is adapted to communicate single channel optical data packets over the single channel ring network 1. To this end, the ring nodes 2 each comprise two fixed-tuned transceivers, one for each single channel fiber 11, 12, as will be described in more detail below with respect to FIG. 2.

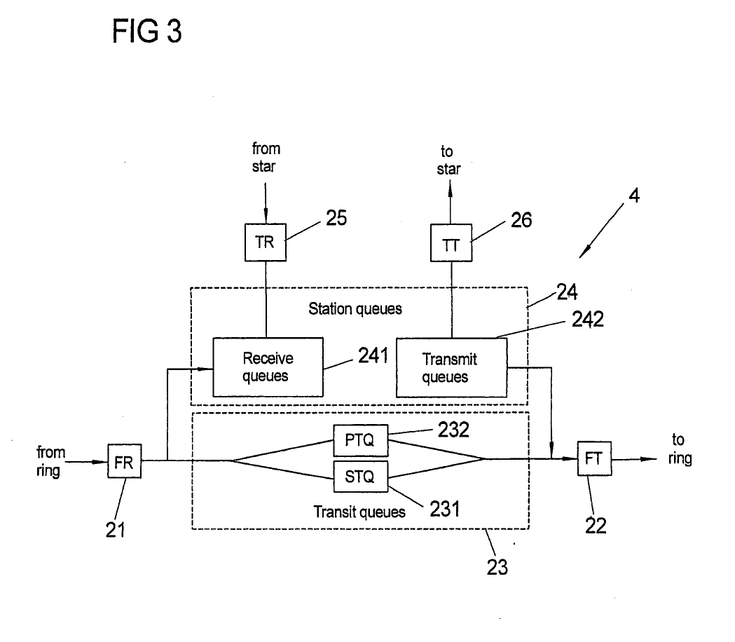

The hybrid network additionally includes a star subnetwork 3. The star subnetwork 3 comprises a plurality of subset nodes 4 which are a subset of the ring nodes 2 of the single channel ring network 1. As will be explained in more detail with respect to FIG. 3, each subset node 4 of the star subnetwork 3 comprises a tunable transmitter and a tunable receiver to communicate optical data packets over the star subnetwork 3.

The star subnetwork 3 additionally comprises a central wavelength router 5, which preferrably is a single arrayed waveguide grating (AWG). The AWG 5 comprises D input ports and D output ports, D≧2. In addition, there are provided a plurality of wavelength insensitive combiners 6 and of wavelength insensitive splitters 7. The combiners 6 include S input ports and one output port, S≧1. The splitters 7 include one input port and S output ports. In the embodiment of FIG. 1, S=D=2.

If S=1, combiners would not be used. In such case, each node of the star subnetwork would be connected to a separate input port of the AWG 5.

The tunable transmitter of a given subset node 4 is connected to a combiner 6 input by using one fiber. Its tunable receiver is connected to the opposite splitter 7 output pair by using one fiber. The output port of the combiners 6 are connected to the input ports of the AWG 5. The input ports of the splitters 7 are connected to the output ports of the AWG. Accordingly, there are D combiners 6 and D splitters 7.

Optionally, between the combiners 6 and the AWG 5 as well as between the AWG 5 and the splitters 7 optical amplifiers 8 such as Erbium doped fiber amplifiers are placed to compensate for fiber losses, splitting losses and insertion losses.

FIG. 2 diagrammatically depicts the main components of a ring node 2 of the single channel optical ring network 1. The ring node 2 comprises a fixed-tuned receiver FR 21, which converts the incoming optical data to electrical data. Depending on whether the received data are routed to another ring node 2 or are received at the given ring node 2, the data are sent to transit queues 23 or station queues 24.

The transit queues 23 comprise two queues, one for guaranteed class A traffic (primary transit queue—PTQ) 232 and one secondary transit queue STQ for class B (committed rate) and class C (best effort) traffic. If both queues PTQ 232 and STQ 231 are not full, highest priority is given to MAC traffic of the known MAC protocol. If there is no local control traffic, PTQ traffic is served always first. If PTQ 232 is empty, the local transmission queue (stage queue) is served until STQ 231 reaches a certain queue threshold. If STQ 231 reaches that threshold, STQ in-transit ring traffic is given priority over station traffic such that in-transit packets are not lost due to buffer overflow. This is in accordance with Resilient Packet Ring (RPR) IEEE 802.17 standard.

It is pointed out that this embodiment of the transit queues 23 is only exemplary. In an alternative embodiment, a single queue with a single FIFO queue is used.

The station queues 24 comprise one receive queue 241 and one transmit queue 242. The receive queue 241 comprises data packets that are received at the given ring node 2 for further processing. The transmit queue 242 comprises data packets that are put on the optical ring network at the ring node 2.

As the optical ring network is a single channel, i.e., a single wavelength network, the receiver 21 and the transmitter 22 are fixed-tuned receivers and transmitters, respectively. The transmitter 22 converts the electrical data to optical data and puts the optical data on the ring. In addition, signal regeneration such as 3R signal regeneration including reamplifying, reshaping and retiming may be carried out in the electrical part of the node 2.

FIG. 3 diagrammatically depicts a subset node 4 which belongs both to the single channel optical ring network 1 and the star subnetwork 3. The subset node 4 comprises the elements of a ring node 2 as described with respect to FIG. 2, such that reference is made to FIG. 2 in that respect. In addition, a tunable receiver 25 and a tunable transmitter 26 are provided. The tunable receiver 25 is connected to the receive queues 241. The tunable transmitter 26 is connected to the transmit queues 242. By means of the tunable transmitter 26, optical data can be transmitted from the given subset node 4 across the star subnetwork 3. The tunable receiver 25 is used to detect optical signals received from the star subnetwork 3 and to convert them into electrical signals.

Preferrably, all queues are implemented as FIFO queues.

It is pointed out that each subset node 4 is equipped with two transit queues 23 and two station (receive and transmit) queues 24, one for each fiber ring of the bidirectional ring 1, and two additional station (receive and transmit) queues for the star subnetwork. However, only one set of PTQ and STQ queues 23 is shown in FIG. 3. The same is true for the ring nodes 2 of FIG. 2.

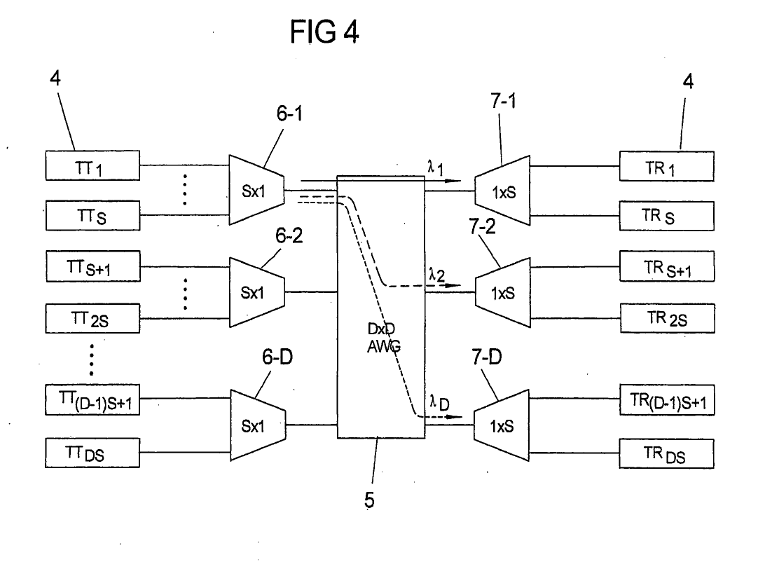

FIG. 4 shows the network structure of the star subnetwork 3. The single central AWG 5 is a frequency-cyclic D×D arrayed waveguide grating with D input ports and D output ports, where D≧2.

The subset nodes 4 of the star subnetwork 3 each includes a tunable transmitter TT and a tunable receiver TR, as explained with respect to FIG. 3. The total number of subset nodes 4, and accordingly of tunable transmitters TT and tunable receivers TR is S×D, with S being the number of input ports of the combiners 6-1, 6-2, . . . , 6-D. S is also the number of output ports of the splitters 7-1, 7-2 . . . , 7-D.

To the input ports of a first S×1 combiner 6-1 are connected S tunable transmitters TT₁, . . . , TT_{S}. To the input ports of a second combiner 6-2 are also connected S tunable transmitters TT, etc. Each combiner 6-1, 6-2, . . . , 6-D collects data from S attached tunable transmitters TT and feeds them into one AWG input port.

The output ports of a first 1×S splitter 7-1 are connected to S tunable receivers TR₁, . . . , TR_{S}. The same is true for further splitters 7-2, . . . , 7-D, each connected to an output port of the AWG 5. By using the splitters 7-1, 7-2, . . . , 7-D, the AWG output port signals of a given output port are equally distributed to S attached tunable receivers TR by the wavelength-insensitive 1×S splitters. These wavelength-insensitive splitters also enable optical multicasting.

The wavelength λ1, λ2, . . . λ_{D} of the tunable transmitters TT and of the tunable receivers TR determines the route of data packets encoded by signals of that wavelength λ1, λ2, . . . λ_{D} through the AWG 5 and, accordingly through the star subnetwork 3. The AWG 5 routes different wavelengths λ1, λ2, . . . λ_{D} from tunable transmitters TT₁ . . . TT_{S} and combined at combiner 6-1 to different output ports of the AWG 5. The same is true for wavelengths applied to the AWG through the other combiners 6-2 . . . 6-D. The AWG 5 routes wavelengths such that no collisions occur at the AWG output ports, i.e., each wavelength can be applied to all AWG input ports simultaneously. In other words, with a D×D AWG each wavelength can be spatially reused D times.

Additional wavelengths can be used if several free spectral ranges (FSR) of the AWG 5 are used. The free spectral range is also known as the demultiplexer periodicity. This periodicity is due to the fact that constructive interference at the output ports occurs for a number of wavelengths. One can also describe the free spectral range as the spectral distance to the next diffraction order of the grating of the AWG.

Using R FSRs, R≧1 allows for R simultaneous transmissions between each AWG input port and output port pair. Thus, the total number of wavelength channels available for routing at each AWG port is D times R, where R≧1.

Accordingly, each transmitter TT and each receiver TR needs to be tunable over R×D contiguous wavelength channels in order to provide full connectivity in one single hop over the central router 5. Alternatively, a subset of the tunable transmitters TT and the tunable receivers TR are tunable over D contiguous wavelength channels only, with different tunable transmitters TT and tunable receivers TR being tunable over wavelengths of different free spectral ranges of the AWG 5. However, this way a restriction occurs regarding which subset nodes of the star subnetwork can communicate. If R=1, it is sufficient that the transmitters and receivers are tunable over D contiguous wavelength channels in order to provide full connectivity in one single hop.

To route data packets from a first given subset node and its tunable transmitter TT to a second given subset node and its tunable receiver TR, a wavelength of the number of wavelengths R×D has to be determined and the respective tunable transmitter and tunable receiver have to be tuned to that wavelength. Once this is carried out, the route of the data packets through the AWG 5 and thus through the star subnetwork 3 is determined.

The wavelength channel access of the tunable transmitters and receivers is arbitrated by means of a reservation protocol with pretransmission coordination, as will be further described.

Referring again to FIG. 1, it is now discussed the transport of data packets between a given source ring node A and a given destination ring node B of the hybrid network. Both nodes A and B are ring nodes 2 only and not part of the star subnetwork 3.

The data packets to be sent from node A to node B are first put on the optical ring network 1 at the source ring node A. It is then determined a route for the data packets being sent from the source node A to the destination node B. Such determination is made, e.g., by a network management system and/or routing protocols. Preferably, the shortest path through the network from node A to node B is determined to keep a high network capacity for newly generated traffic.

The shortest route is the route that requires the lowest number of hops from one node to an adjacent hop on the way a packet takes from the source node A to the destination node B. In the example discussed in FIG. 1, it would take a data packet seven hops to travel to node B across the ring network and four hops to travel to the node B by taking the short cut between subset nodes 4 over the star subnetwork 3. Accordingly, the route across the star subnetwork 3 is the shortest route.

It is determined which source subset node 4 and destination subset node 4 of the subset are part of the shortest route. These subset nodes receive information to route data packets from source node A via the star subnetwork 3 to the destination subset node. To this end, e.g., the routing tables of the subset node 4 are updated accordingly by means of control packets.

The data packets sent from node A are then pulled from the optical ring 1 at the source subset node 4 closest to the source node A. The data are transmitted over the star subnetwork 3 to the destination subset node 4 closest to the destination node B. To this end, optical-electrical-optical conversion of the data is carried out at the nodes and a specific wavelength is assigned to the data packets which are sent over the star subnetwork 3. The assigned wavelength determines the route of the data packets through the star subnetwork 3. The tunable transmitter 26 and the tunable receiver 25 of the respective subset nodes 4 are tuned to that wavelength.

Once the data packets routed through the star subnetwork 3 are received at the destination ring node 4, the data packets are sent from the destination subset node 4 over the optical ring network 1 to the destination node B. The destination node B takes the data packets from the optical ring network 1 (destination stripping).

Once a data packet is safely received at the destination node B, an acknowledgement ACK control packet is sent to the source node A. This preferably is done over the ring network 1 only. The acknowledgement control packets as well as reservation control packets are implemented in the media access control (MAC) level of the network.

The invention introduces the novel concept of “proxy stripping”, how the routing of data packets as described above is termed.

With proxy stripping, other than with source stripping or destination stripping, a subset node (which may also be termed ring-and-star homed node) which is neither a source node nor a destination node pulls incoming data from the ring network and sends them across the star subnetwork 3 in a single-hop short-cut over the AWG 5.

If the shortest route between a given source and destination node does not include the star subnetwork 3, then destination stripping without proxy stripping is used. For example, if in FIG. 1 data are sent from a source node A to a destination node B′, the shortest route would be that over the peripheral ring network 1. In such case, proxy stripping would not be executed.

Using proxy stripping, and additional referring to FIG. 3, a subset node 4 takes the corresponding data packets from the ring and places the data packets in its star transmit queue 242. As mentioned above, a subset node 4 only pulls data packets from the ring, if the minimum hop distance between a given source node 2 and a given destination node 2 on the ring 1 is larger than the minimum hop distance between a given source node 2 and a given destination node 2 via short-cuts across the star subnetwork 3.

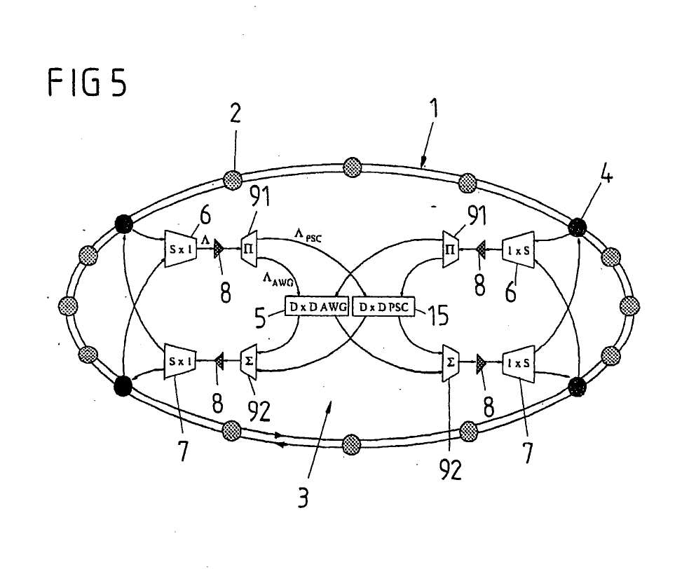

Packets in the star transmit queue 242 are sent by using a reservation protocol with pretransmission coordination. Prior to transmitting a data packet, the corresponding subset node 4 broadcasts a control packet on one of the fiber rings by means of source stripping or across a wavelength insensitive PSC (see FIG. 5). The control packet preferably consists of three fields: first, the source address of the proxy-stripping source subset node, second, the destination address of the destination subset node that is closest to the destination node and, third, the length of the corresponding data packet. Each subset node 4 receives the broadcast control packet and is thus able to acquire and maintain global knowledge of all subset nodes 4 reservation requests. Based on this global knowledge, all subset nodes 4 schedule the transmission and reception of the corresponding data packets over the star subnetwork 3 in a distributed fashion. For example, a deterministic first-come-first-served and first-fit scheduling algorithm is used.

The described hybrid network allows for an evolutionary WDM upgrade of an optical single channel ring network in that it builds into the single-channel node structure while leaving the ring network unchanged. Only a subset of the ring nodes of the single channel ring network needs to be upgraded. Accordingly, nodes can be upgraded and connected to the star subnetwork via dark fibers one at the time in a pay-as-you-grow manner. The described hybrid network requires only one single router, which is sufficient to provide for single-hop interconnection among all subset nodes. The central wavelength router is highly reliable due to its passive nature.

In an alternative embodiment of the star subnetwork, the star subnetwork does not implement splitters 7. Instead, the exit ports of the AWG 5 are connected directly via fibers to tunable receivers of the subset nodes 4. Although multicasting is not possible in this embodiment, a point to point connection is still possible.

In a further alternative embodiment, the single channel optical ring network is a unidirectional ring network with one peripheral fiber only, such that data can be sent over the ring network in one direction only. By using a bidirectional network, the spatial reuse of bandwidth is increased. It is further possible to use a bidirectional single-fiber ring network.

FIG. 5 shows a hybrid optical network that, in comparison with the hybrid optical network of FIG. 1, additionally includes a passive star coupler (PSC) 15 which is located in parallel with the central AWG 5. In the following, only those features of the hybrid optical network are described which are in addition to the features of the hybrid optical network of FIG. 1. The components discussed in FIG. 1 are also present in the hybrid optical network of FIG. 5.

The passive star coupler 15 has D input ports and D output ports, where D≧2. The passive star coupler 15 has thus the same number of input ports and output ports as the central AWG 5. The passive star coupler 15 functions like a D×1 combiner and a 1×D splitter interconnected in series. Accordingly, it collects wavelength channels from all D input ports and equally distributes them among all D output ports. Similar to the splitters 7, a given wavelength channel can be received at all D output ports. Similar to the combiners 6, to avoid channel collisions at the output ports, a given wavelength channel can be used only at one of the D input ports at any time.

The input ports of the passive star coupler 15 are each connected to a waveband partitioner 91. Each waveband partitioner 91 is located between the output port of a combiner 6 and an input port of the AWG 5 and the PSC 15. In case the signals are amplified by an optical amplifier 8, the waveband partitioner 91 is preferably arranged between such optical amplifier 8 and the AWG 5 and PSC 15.

The waveband partitioner 91 has one input port and two output ports. It partitions an incoming set of contiguous wavelength channels Λ into two wavebands (subbands Λ_{AWG} and Λ_{PSC}) where Λ=Λ_{AWG}+Λ_{PSC}. Each waveband Λ_{AWG}, Λ_{PSC} is routed through a different output port. One output port of the waveband partitioner 91 is connected to an input port of the AWG 5 and one output port of the waveband partitioner 91 is connected to one input port of the PSC 15.

In a symmetrical manner, there are also provided waveband departitioners 92. Each waveband departitioner 92 has two input ports and one output port, the input ports being connected to the AWG 5 and the PSC 15, respectively, and the output port being connected to the input port of a splitter 7 or, if present, an optical amplifier 8 arranged between the waveband departitioner 92 and the splitter 7. The waveband departitioner 92 collects the two different wavebands Λ_{AWG} and Λ_{PSC} of contiguous wavelength channels from the two input ports. The combined set of Λ wavelength channels is launched onto the common output port, where Λ=Λ_{AWG}+Λ_{PSC}.

The waveband Λ_{AWG} comprises D×R contiguous wavelength channels, i.e., Λ_{AWG}=D×R. R denotes, as explained above, the number of used FSRs of the underlying AWG 5. The second waveband Λ_{PSC} comprises 1+D×S contiguous wavelength channels, i.e., Λ_{PSC}=1+D×S. There is provided in waveband Λ_{PSC} one control channel with wavelength λ_{C} and D×S data channels, one for each subset node 4 of the star subnetwork. A set of Λ wavelength channels are combined by means of S×1 combiner 6 which collects individual wavelength channels from S subset nodes, where S≧1 as explained with respect to FIG. 1. The wavelength channels are split into two wavebands by waveband partitioner 91. The waveband departitioner 92 collects the two wavebands Λ_{AWG} and Λ_{PSC} from each pair of output ports of both AWG 5 and PSC 15. The combined set of wavelength channels is equally distributed among the S attached subset nodes by means of the 1×S splitter 7, where S≧1.

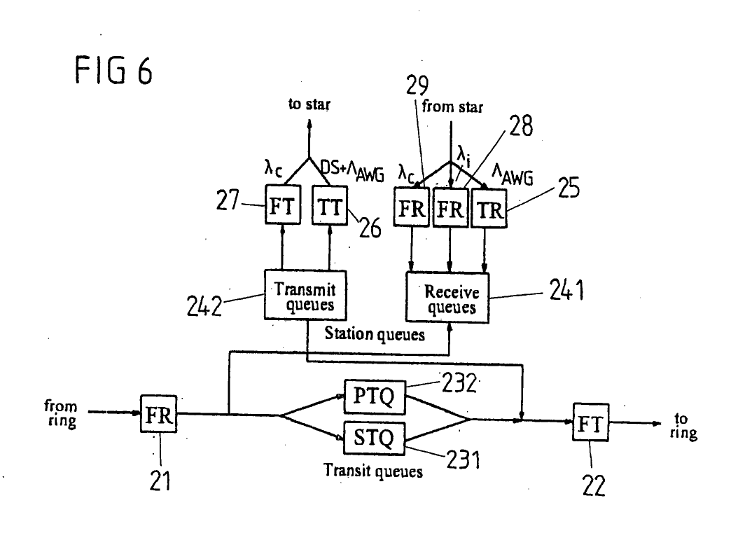

The addition of a passive star coupler 15 to the hybrid optical network requires a modified structure of the subset nodes 4, which are both part of the ring network 1 and the star subnetwork 3. Such modified structure of a subset node 4 is depicted in FIG. 6.

The subset node 4 of the hybrid network of FIG. 5 comprises the elements of a subset node as described with respect to FIG. 3, such that reference is made to FIG. 3 in that respect. In addition, there are provided a fixed tuned transmitter 27 for additionally transmitting control and data signals into the star subnetwork and two fixed-tuned receivers 28, 29 for additionally receiving signals from the star subnetwork.

The additional fixed-tuned transmitter 27 is tuned to a control wavelength channel λ_{C} of waveband Λ_{PSC}. As mentioned above, Λ_{PSC}=1+D×S. The remaining D×S wavelength channels of the waveband Λ_{PSC} and all wavelength channels of waveband Λ_{AWG} are accessed for data transmission by the tunable transmitter 26 whose tuning range equals:

D×S+Λ_{AWG}=D(S+R).

For reception of signals from the star subnetwork, additional fixed-tuned receiver 29 is tuned to the control wavelength channel λ_{C} of waveband Λ_{PSC}. In addition, further additional fixed-tuned receiver 28 is provided for data reception on the passive star coupler 15. The further fixed-tuned receiver 28 is operated at its own dedicated home channel λᵢ which is one of the wavelength channels of Λ_{PSC}. Accordingly, each data wavelength channel of waveband Λ_{PSC} is dedicated to a different subset node 4 for signal reception. Consequently, data packets transmitted on PSC 15 data wavelength channels do not suffer from receiver collision. In this respect, it is noted that a receiver collision occurs when the receiver of the intended destination node is not tuned to the wavelength channel on which the data packet was sent by the corresponding source node.

In addition, on the wavelength channels of waveband Λ_{AWG}, data packets are received by the tunable receiver 25 as explained with respect to FIG. 1 to 4.

It is pointed out that transit queues 231, 232 are depicted in FIG. 6 only for one single channel fiber of the bi-directional dual fiber ring which consists of two peripheral fibers 11, 12 each carrying one wavelength. Transit queues as well as one transmit and one receive queue are also provided for the other ring. In addition to these transit queues and station queues, each subset node has a separate transmit queue for each transmitter (either fixed-tuned or tunable) and a separate receive queue for each receiver (either fixed-tuned or tunable). Accordingly, besides the four transit queues (two for either ring), each subset node has four transmit queues and five receive queues in total. Preferably, all queues are FIFO queues.

It will now be discussed the benefits of adding a passive star coupler 15 as explained with respect to FIGS. 5 and 6 to the hybrid optical network of FIG. 1.

First, the wavelength channel λ_{C} of fixed wavelength allows to broadcast control information to all other subset nodes 4. It is thus possible to send control data to all other subset nodes 4 over the star subnetwork 3, without occupying bandwidth on the ring network 1 and without bothering ring nodes 2 which are not subset nodes with the routing of such control data. An example for such control data are control data which are used in a reservation protocol with pretransmission coordination, e.g., when informing the subset nodes 4 about reservation requests when sending data packets over the AWG 5.

Also, using the wavelength channel Λ_{C}, large amounts of data can be multicast to a plurality of receivers without using the ring network 1.

Second, the further D×S wavelength channels of waveband Λ_{PSC} can be used to send data over the PSC 15 to a specific destination node 4 which is part of the star subnetwork. To this end, a tunable transmitter 26 of a source subset node will tune to a specific wavelength λᵢ to which the fixed-tuned receiver 28 of one of the destination subset nodes is fixed-tuned. Although the data packets sent out from tunable transmitter 26 will be broadcast by the PSC 15 to all other subset nodes 4, only the one subset node with its fixed-tuned receiver 28 tuned to wavelength λᵢ will be able to detect these signals. Compared with the transmission of data over AWG 5, it is not required to perform wavelength tuning at the destination node. The receiver of the intended destination is always tuned to its dedicated wavelength channel λᵢ. However, an additional fixed-tuned receiver 28 is required at the subset node 4.

In supplementing the star subnetwork of FIG. 1 with a passive star coupler 15, additional possibilities and flexibility in routing data packets to a destination node are provided.

It is pointed out that the novel concept of “proxy stripping” as explained with respect to FIG. 1 to 4 also applies to the hybrid optical network of FIG. 5. Obviously, short cuts over the star subnetwork can be routed over the AWG 5 or the PSC 15.

The invention is not restricted in its configuration to the exemplary embodiments presented above, which are to be understood as only given by way of example. A person skilled in the art recognizes the existence of numerous alternative variants for the embodiment, which, in spite of their departure from the exemplary embodiments described, make use of the teaching defined in the claims.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. A hybrid optical network comprising:
a single channel optical ring network,
a plurality of ring nodes of the single channel optical ring network, each of the ring nodes being adapted to communicate single channel optical data packets over the single channel ring network,
a star subnetwork comprising:
a central wavelength router having a plurality of input ports and a plurality of output ports,
a plurality of combiners each having a plurality of input ports and one output port, the output ports of the combiners being connected to the input ports of the central wavelength router,
a subset of the ring nodes of the ring network, each node of the subset including a tunable transmitter and a tunable receiver to communicate optical data packets over the star subnetwork, the tunable transmitters each being connected to an input port of one of the combiners, wherein
optical data packets routed between two ring nodes of the subset over the star subnetwork are assigned a specific wavelength that determines the routing of the data packets through the central wavelength router.

25. The network according to claim 24, wherein the central wavelength router is a single arrayed waveguide grating.

26. The network according to claim 24 or 25, additionally comprising a plurality of wavelength independent splitters each having one input port and a plurality of output ports, the input ports of the splitters being connected to the output ports of the central wavelength router, the output ports of the splitters each being connected to a tunable receiver of one of the nodes of the subset.

27. The network according to claim 24, wherein the nodes of the subset are equally distributed among the ring nodes.

28. The network according to claim 24, wherein an optical amplifier is arranged between the output port of a combiner and the corresponding input port of the central wavelength router.

29. The network according to claim 26, wherein an optical amplifier is arranged between an output port of the central wavelength router and the input port of the corresponding splitter.

30. The network according to claim 24, wherein each node of the subset comprises conversion means for optical to electrical to optical conversion of the signals, and wherein the tunable transmitter and the tunable receiver of a node perform electrical to optical and optical to electrical signal conversion, respectively.

31. The network according to claim 30, wherein each node of the subset comprises transit queues and station queues, the station queues comprising receive queues and transmit queues, one receive queue being connected to the tunable receiver and one transmit queue being connected to the tunable transmitter.

32. The network according to claim 24, further comprising protocol means for routing optical data packets to be sent from a given source ring node to a given destination ring node over the shortest network path, including routing the data packets over the single channel ring network and over the star subnetwork.

33. The network according to claim 24, additionally comprising:
means for assigning a wavelength to data packets being sent over the star subnetwork from a given source subset node of the subset to a given destination subset node of the subset, the wavelength determining the route of the data packets through the star subnetwork,
means for tuning the tunable transmitter of the source subset node to the assigned wavelength, and
means for tuning the tunable receiver of the destination subset node to the assigned wavelength.

34. The network according to claim 33, wherein the means for assigning a wavelength comprise:
means for determining the shortest route for data packets being sent from a given source ring node to a given destination ring node)
means for determining within the shortest route a source subset node and a destination subset node routing the data packets over the star subnetwork in a short-cut,
means for determining a wavelength to route the data packets from the source subset node to the destination subset node.

35. The network according to claim 33, further comprising means for putting the data packets received at the destination subset node on the single channel optical ring network in case the destination subset node is different from the destination node.

36. The network according to claim 24, wherein the single channel optical ring network is a bidirectional dual-fiber ring network or a bidirectional single-fiber ring network.

37. The network according to claim 24, wherein the hybrid optical network is a packet switched metropolitan area network.

38. The network according to claim 24, wherein a passive star coupler is arranged in parallel with the central wavelength router, each node of the subset being coupled both to the central wavelength router and the passive star coupler, and with the central wavelength router routing data packets assigned to wavelengths of a first waveband and the passive star coupler routing data packets assigned to wavelengths of a second waveband.

39. A method of routing data packets between a source ring node and a destination ring node of a hybrid optical network that comprises a peripheral optical ring network with a plurality of ring nodes and a star network with a central wavelength router and a subset of the ring nodes, each node of the subset including means to communicate optical data packets over the star subnetwork, the method comprising:
putting data packets to be transmitted on the optical ring network at the source ring node,
determining a source subset node and a destination subset node of the subset which are part of a route for data packets being sent from the source ring node to the destination ring node,
pulling incoming source ring node data packets from the optical ring network at the source subset node,
transmitting the pulled data packets over the star subnetwork to the destination subset node)
sending the data packets from the destination subset node to the destination ring node over the optical ring network if the destination ring node is unequal to the destination subset node, and
taking the data packets from the optical ring network at the destination ring node.

40. The method of claim 39, wherein the source subset node and the destination subset node are nodes of the shortest route for data packets from the source ring node to the destination ring node over the hybrid network.

41. The method of claim 39 or 40, wherein the optical ring network is a single channel optical ring network, the optical data packets pulled from the single channel optical ring network being converted in the source subset node to an optical wavelength that allows routing of the data packets to the destination subset node over the star subnetwork.

42. The method of claim 41, wherein the optical data signals on the optical ring network are converted to electrical data signals when taken from the ring, and wherein the electrical data signals are converted to optical data signals of a specific wavelength that determines the routing of the data signals across the star subnetwork.

43. The method of claim 42, wherein the optical data signals are placed in a transmit queue when taken from the optical ring network and transmitted from the transmit queue to a tunable transmitter of the source subset node.

44. The method of claim 42, additionally comprising the step of regenerating the signal after conversion to an electrical signal.

45. The method of claim 39, additionally comprising the step of the source subset node transmitting control data with node reservation information to the other nodes of the subset prior to transmitting the data packets over the star subnetwork.

46. The method of claim 45, wherein the node reservation information comprises data about the source address of the source subset node, data about the destination address of the destination subset node and data about the length of the corresponding data packet.
